(19) United States
(12) Patent Application Publication
(10) Pub. No.: US 2007/0181808 A1
(43) Pub. Date: Aug. 9, 2007

(54) Electron microscope and electron bean inspection system.

(76) Inventors: Hisaya Murakoshi, Tokyo (JP); Hideo Todokoro, Hinode (JP); Hiroyuki Shinada, Mitaka (JP); Masaki Hasegawa, Sayama (JP); Momoyo Enyama, Kokubunji (JP)

Correspondence Address: Stanley P. Fisher;Reed Smith LLP, Suite 1400, 3110 Fairview Park Drive, Falls Church, VA, 22042-4503, US

(21) Appl. No.: 11/701,386

(22) Filed: Feb. 2, 2007

(30) Foreign Application Priority Data
Feb. 6, 2006 (JP) 2006-027850

(51) Int. Cl. G21K 7/00

(52) U.S. Cl. 250/310

(57) ABSTRACT

While an image obtained by a general electron microscope is affected by the shape and material of an object specimen, an image obtained from mirror electrons is affected by the shape of an equipotential surface on which the mirror electrons are reflected, thereby the image interpretation is complicated. A mirror electron microscope of the present invention is provided with the following means for controlling a reflecting plane of the mirror electrons according to the structure of an object pattern to be measured or a concerned defect.

1) Means for controlling a potential difference between a specimen and an electron source equivalent to a height of a reflecting plane of a mirror electron beam according to a type, an operation condition of an electron source, and a type of a pattern on a specimen.
2) Means for controlling an energy distribution of an illuminating beam with an energy filter 9 disposed in an illuminating system.
It is thus possible to inspect a specimen according to a size and a potential of a pattern, which are distinguished from others.

### CLAIM OF PRIORITY

The present application claims priority from Japanese application JP 2006-027850 filed on Feb. 6, 2006, the content of which is hereby incorporated by reference into this application.

### FIELD OF THE INVENTION

The present invention relates to a reflection electron microscope such as a mirror electron microscope for observing a state of a surface of a specimen (semiconductor specimen, or the like) or a defect inspection system for inspecting a pattern defect, a foreign matter, etc. on a semiconductor wafer using the reflection electron microscope.

### BACKGROUND OF THE INVENTION

There is a detecting method for circuit pattern defects on a wafer by comparing images in a manufacturing process of a semiconductor device. According to the method, an electron beam is illuminated onto a specimen to detect fine etching residuals under the resolving power of the optical microscope, such shape defects as fine pattern defects, as well as such electrical defects as non-aperture of fine through holes, etc. In the case of a detecting method that uses a scanning electron microscope that scans a point electron beam on a specimen, the method has a limit in obtaining a practical scanning speed. To achieve the above object, Japanese Patent Laid-Open Publication (JP-A) No. 249393/1995, JP-A No. 197462/1998, and JP-A No. 202217/2003 describe so-called projection type high speed inspection systems. In each of the inspection systems, a rectangular electron beam is illuminated through a lens onto a semiconductor wafer to form an image of electrons that are reflected without being illuminated onto the wafer due to back-scattered electrons, secondary electrons, or forming of a back electric field.

### SUMMARY OF THE INVENTION

However, the projection type microscope that uses secondary electrons and mirror electrons suffers from the following problems.

A system for magnifying and projecting such detected electrons as secondary electrons and back-scattered electrons is referred to as a low energy electron microscope. This method can illuminate an electron beam of a larger current than that of the SEM method, thereby it is possible to obtain images at a time. Thus the method is expected to form images much faster than the SEM method. However, the secondary electrons are scattered widely and the energy is spread widely in a range of about 1 to 10 eV. When focusing such electrons to form a magnified image of an object specimen, the resolution is not enough unless otherwise most of the secondary electrons are eliminated. This is understood easily from FIG. 6 in a reference document “the minutes of LSI Testing Symposium/1999, p 142”. This FIG. 6 shows a relationship between a negative specimen applying voltage for accelerating secondary electrons emitted from the specimen and a secondary electron image resolution.

As shown in FIG. 6, the resolution is almost 0.2 μm when the specimen applying voltage is −5V. At this time, all the emitted secondary electrons are not always available for forming an image. In the calculation in the above described minutes, for example, the result is obtained by using a beam having an opening angle of a 1.1 mrad or under on an imaging plane after the electrons pass an objective lens. The secondary electrons to be used within the range of this opening angle are about 10% at most. In addition, in the calculation, the width of the energy of the secondary electrons used for image formation is assumed as 1 eV. Actually however, the width of the energy of emitted secondary electrons is several eV or over and the tail of the high energy part is extended up to about 50 eV. If secondary electrons just within an energy width of 1 eV at most are extracted from among the secondary electrons of which energy is distributed such widely, the secondary electrons to be used for image formation will become much more reduced, for example, up to several fractions.

Such way, because the rate of the secondary electrons usable for image forming actually is low, it is difficult to secure a proper S/N ratio of images even when using the secondary electrons obtained by illuminating a large current onto a specimen with an area electron beam to form images at a time. Thus the inspection time cannot be reduced as expected. Even when back-scattered electrons are used for image forming, the number of the back-scattered electrons to be emitted is two digits smaller than those of an illumination beam current. Thus it is difficult to achieve a good balance between high resolution and high speed like the case using secondary electrons.

There is another system that magnifies and projects mirror electrons reflected without colliding with the object specimen just before it instead of using secondary electrons and back-scattered electrons. The system is referred to as a mirror electron microscope. This mirror electron microscope can be used to detect disturbed potentials and shapes caused by defects, thereby detecting defects. If an object pattern has any protruded part or is negatively charged, the equipotential plane formed on the specimen functions like a convex lens with respect to entered electrons. If the pattern has any recessed part or is more positively charged than the peripheral areas, the equipotential plane formed on the specimen functions like a concave lens. These convex or concave lenses on the specimen cause the mirror electrons to slightly change their trajectories. To cope with this, the focal condition of the imaging lens is adjusted, in order to use most of those mirror electrons for image forming. In other words, using mirror electrons such way makes it possible to obtain images with a high S/N ratio and to reduce the inspection time.

While general electron microscopes are manufactured by considering shapes and materials of specimens, images obtained from mirror electrons are affected by shapes of equipotential surfaces from which mirror electrons are reflected, thereby images have had to be interpreted differently from conventional ones. This is why the contrast of images obtained from mirror electrons come to depend significantly on the imaging electron beam focal condition, as well as on the electron beam illumination condition for specimens.

Under such circumstances, it is an object of the present invention to solve the above-described conventional problems to obtain stable mirror electron images and provide a defect inspection system capable of detecting defects of a pattern formed on a wafer quickly and very accurately.

The objects of the present invention are achieved with the following methods.

The first method of the present invention inheres means provided for controlling a reflecting plane that reflects mirror electrons. Concretely, if 0V is assumed as a voltage applied to an electron source and Vs is assumed as a voltage applied to a specimen, an entered electron beam is reflected without colliding with the specimen when Vs<V0 is satisfied, that is, when Vs reaches a negative potential under V0. Such a condition is referred to as a mirror reflection condition. However, the means of the present invention provided for controlling this potential difference V0−Vs can optimize the contrast of mirror electron images.

In other words, a distortion of an equipotential surface located just above a specimen with respect to a different size pattern is extended as follows; the distortion of a large pattern is extended further than that of a small pattern on a specimen. For example, in the case of a solid pattern shown in FIG. 4, the equipotential surface variation depends on the height of the object pattern. If the mirror electron beam reflecting plane is put closer to the specimen, the image can be obtained by including the distortions of both the large pattern and the small pattern. However, if the mirror electron beam reflecting plane is put further from the specimen, the image to be obtained can include only the distortion of the large pattern. For example, while observing a specimen having a pattern on its fine uneven surface, information can be obtained from both the fine unevenness and the pattern if the mirror electron beam reflecting plane is put closer to the specimen. When inspecting pattern shape defects, however, images to be obtained can include only the pattern information extracted by moving the mirror electron beam reflecting plane away from the specimen.

The voltage contrast of the specimen surface is also the same; the equipotential surface variation depends on the size of the specimen surface potential. FIG. 5 (A and B) show how an equipotential surface varies from a Vs−2V charged pattern and a Vs−0.5V charged pattern and how an illuminating electron beam trajectory changes according to a 5 kV/mm electric field applied between a specimen having a potential Vs and an electrode facing the specimen. In FIG. 5, the equipotential surface interval is 0.2V and the equipotential surfaces are distributed at intervals of about 40 nm in average. FIG. 5A shows an electron trajectory along which electrons are illuminated onto the specimen in parallel perpendicularly to the specimen with an energy of e(Vs−0.2V); the energy of the electrons on the Vs−0.2V equipotential surface becomes almost zero and the electrons is reflected in different directions. Furthermore the mirror electron beam trajectory is diverged and changed because of the equipotential surface variation from the −0.5V charged pattern and the −2V charged pattern, enabling both patterns to be detected. On the other hand, FIG. 5B shows a trajectory of electrons illuminated in parallel perpendicularly to the specimen with an energy of e(Vs−0.4V) The Vs−0.4V equipotential surface becomes a reflecting plane at which the energy of the illuminating electron beam becomes almost zero. Therefore, the electron trajectory is diverged due to an equipotential surface change from a −2V charged pattern while the equipotential surface change from a −0.5V charged pattern is less, thereby the mirror electron beam is reflected almost perpendicularly. Consequently the −2V pattern can be selected and detected under this illuminating condition.

As described above, if means for controlling the reflecting plane of an illuminating electron beam to be assumed as a mirror electron beam is provided according to the type and state of the object specimen, pattern sizes and charged levels can be distinguished, thereby observation and inspection are made more quickly and accurately.

The second method of the invention inheres a method for controlling an energy distribution of an illuminating electron beam. An illuminating electron beam emitted from an electron source have a certain pattern of energy spread according to the type and the operating condition of the electron source. If such an illuminating electron beam is emitted with a large current, the beam is affected by the coulomb interaction among electrons, thereby the beam reaches the object specimen with more widely spread energy. If the energy of an illuminating electron beam is distributed such way, low energy electrons come to be reflected far away from the specimen even when the specimen and the electron source applying condition are set to satisfy a condition that high energy electrons are reflected just on the specimen. To solve the above described problem, the means for controlling an energy distribution of an illuminating electron beam is provided to control the reflecting surface. In other words, an energy filter is disposed between the electron source and the specimen so as to narrow the energy distribution of the illuminating electron beam, thereby obtaining a mirror electron image from a specific reflecting surface. For example, if only electron beams reflected just before the specimen is imaged, it is possible to obtain a high resolution image that includes fine information of the specimen surface. By comparing a plurality of different images of those reflecting surfaces, the three-dimensional structure of the specimen surface can be restructured. To adjust the reflection surface of the beam of which energy is narrowed as described above, the energy of the beam passing the energy filter is controlled. It is also possible to make such adjustment by combining the controlling means with another means for controlling the difference between the above described electron source potential and the specimen potential.

It is also possible to avoid degradation of the image resolution to be caused by charging of the specimen by eliminating only the high energy part of the electron beam. If an electron beam is illuminated onto an insulation specimen having less current leaks, the specimen surface potential rises up to a negative potential at which no electron comes to collide with the specimen. In other words, as shown in FIG. 6A, if the high energy part of an illuminating electron beam has a tail, the specimen potential rises from the potential Vs (FIG. 6B) at the initial time of illumination up to a potential (FIG. 6C) at which the highest energy part electrons in the tail do not collide with the specimen, thereby the illuminating beam goes away from the specimen. In such a case, it is difficult to obtain fine information of the specimen surface, thereby the image becomes unclear. This is why an energy filter is used in such a case to eliminate only the high energy part of the electron beam. A high resolution image is thus obtained (FIG. 6D) while the illuminating beam does not go away from the specimen.

Furthermore, only the low energy part of the electron beam is eliminated to eliminate the information obtained from the long cycle structure away from the specimen.

If an ExB deflector is used as an energy filter and a separator respectively, the energy filter and the separator can be set so that they make deflection in the counter directions respectively, thereby the deflection aberration of the illuminating beam is reduced. The ExB deflector enables an electric field E and a magnetic field B to be orthogonal to each other and superimposed on one another. Hereinafter, the operation of the ExB deflector will be described with reference to FIG. 7. A deflection angle θ_{E} at which an electron beam having an acceleration voltage V₀ is deflected by a parallel flat plate electrode type electrostatic deflector having a length 21 and an interval d shown in FIG. 7, as well as the deflection angle θ_{H} thereof deflected by a uniform magnetic field deflector having a length 21 are given in the following expression respectively.

$${θ}_{E} = \frac{1}{d} \frac{{V}_{1}}{{V}_{0}} , {θ}_{M} = \sqrt{\frac{2 e}{m}} \frac{B}{\sqrt{{V}_{0}}} 1$$

A condition under which deflection by an electric field and deflection by a magnetic field are canceled each other is referred to as a Wien condition.

$$E = \frac{V 1}{d} = \sqrt{\frac{2 e}{m} {V}_{F} B} . \qquad ( 1 )$$

In FIG. 7, an electron beam entered to an ExB deflector set on the Wien condition from above goes straight and an electron beam entered from below is deflected at θ_{E}+θ_{M}=2θ_{E}.

A deflection quantity Δy of an electron beam having an energy e(V+ΔV) is assumed to be a deflection chromatic aberration of the ExB deflector under the Wien condition and it is approximated in the following expression.

$$Δ y = L [ \frac{1}{d} \frac{{V}_{1}}{{V}_{0} + Δ V} - \sqrt{\frac{2 e}{m}} \frac{B}{\sqrt{{V}_{0} + Δ V}} 1 ] \approx \frac{Δ V}{2 {V}_{0}} {θ}_{E} L \qquad ( 2 )$$

The deflection quantity Δy′ of an electron beam entered from the opposite direction under the Wien condition is calculated as follows by adding the values in parentheses in the above expression.

$$\begin{matrix}Δ {y}^{′} = L [ \frac{1}{d} \frac{{V}_{1}}{{V}_{0}} + \sqrt{\frac{2 e}{m}} \frac{B}{\sqrt{{V}_{0}}} 1 - \frac{1}{d} \frac{{V}_{1}}{{V}_{0} + Δ V} - \sqrt{\frac{2 e}{m}} \frac{B}{\sqrt{{V}_{0} + Δ V}} 1 ] \\ \approx \frac{3 Δ V}{2 {V}_{0}} {θ}_{E} L\end{matrix} \qquad ( 3 )$$

It would be understood that an electron beam entered from the opposite direction under the Wien condition has a chromatic aberration about three times than that of an electron beam going straight.

Here, if an ExB deflector set as an energy filter on the Wien condition is selected and an electron beam having an energy eV goes straight, an energy dispersion quantity of a cross-over formed away from the ExB deflector by a distance L, that is, the deflection quantity Δy of the electron beam having the eV energy with respect to the e(V+ΔV) energy is given as follows in the expression (2). If this Ay deflection quantity is projected by a condenser lens on the focal plane of an objective lens at a magnification Mc, the deflection quantity becomes McΔy. If an illuminating electron beam is deflected at 2θ_{E} by a beam separator (ExB deflector) set on the Wien condition and disposed between the condenser lens and the objective lens, the energy dispersion quantity, that is, the deflection quantity Δy′ of the e (V+ΔV) energy electron beam with respect to the eV energy electron beam is given as follows in the expression (3). Consequently, the energy dispersion quantities of this energy filter and the beam separator are canceled each other on the following condition.

McΔy=−Δy′ (4)

Here, the deflection quantity of the beam separator is fixed due to a positional relationship in the optical system between an illuminating lens and an imaging lens, so that the energy dispersion quantities are canceled each other or eased by adjusting the deflection quantity of the energy filter so as to almost satisfy the expression (4).

Furthermore, if a magnetic field type condenser lens is disposed between an energy filter and a beam separator, the illuminating electron beam is rotated by the magnetic field lens. Thus the deflecting direction must be corrected. Assumed now that the winding number of the excitation coil of the condenser lens is N and the excitation current is I, and the energy of the illuminating electron beam passing the condenser lens is eV. Also assume that the standardized lens excitation Ex is as follows.

Ex=IN/\sqrt{V}

Then, the rotation angle R of the illuminating electron beam is changed by about 11 degrees by the condenser lens with respect to the change of Ex=1. Consequently, to correct the rotation angle R, the deflecting direction of the energy filter is rotated in the counter direction with respect to the condenser lens thereby to ease the deflection aberrations of the beam separator and the energy filter respectively.

### BRIEF DESCRIPTION OF THE DRAWINGS

FIG. 1 is a configuration of a mirror electron microscope in a first embodiment of the present invention;

FIG. 2 is a configuration of a mirror electron microscope in a second embodiment of the present invention;

FIG. 3 is a configuration of a mirror electron microscope in a third embodiment of the present invention;

FIG. 4 is a diagram for describing a distortion of an equipotential surface just above a solid pattern;

FIG. 5A is a diagram for describing a distortion of an equipotential surface, caused by a specimen potential;

FIG. 5B is a diagram for describing a distortion of an equipotential surface, caused by a specimen potential;

FIG. 6A is a diagram for describing an effect obtained by eliminating only a high energy part of an electron beam;

FIG. 6B is a diagram for describing an effect obtained by eliminating only a high energy part of an electron beam;

FIG. 6C is a diagram for describing an effect obtained by eliminating only a high energy part of an electron beam;

FIG. 6D is a diagram for describing an effect obtained by eliminating only a high energy part of an electron beam;

FIG. 7 is a diagram for describing an operation of an ExB deflector;

FIG. 8 is a diagram for describing a voltage distribution in deflection by an 8-pole type ExB deflector in the x deflection;

FIG. 9 is a diagram for describing a current distribution in deflection by the 8-pole type ExB deflector in the x deflection;

FIG. 10 is a cross sectional view of the 8-pole type ExB deflector;

FIG. 11 is a diagram for describing a relationship between the energy distribution and the energy level of a Schottky electron source;

FIG. 12 is a diagram for describing a relationship between the energy distribution and the energy level of a field emission electron source;

FIG. 13 is a diagram for describing a voltage distribution in deflection by the 8-pole type ExB deflector in the y direction;

FIG. 14 is a diagram for describing a current distribution in deflection by the 8-pole type ExB deflector in the y direction;

FIG. 15 is another configuration of a mirror electron microscope in the second embodiment of the present invention; and

FIG. 16 is a diagram for describing how an insulation specimen is illuminated with an electron beam from which only the high energy part is eliminated.

### DETAILED DESCRIPTION OF THE PREFERRED EMBODIMENTS

Hereunder, the preferred embodiments of the present invention will be described with reference to the attached drawings.

### First Embodiment

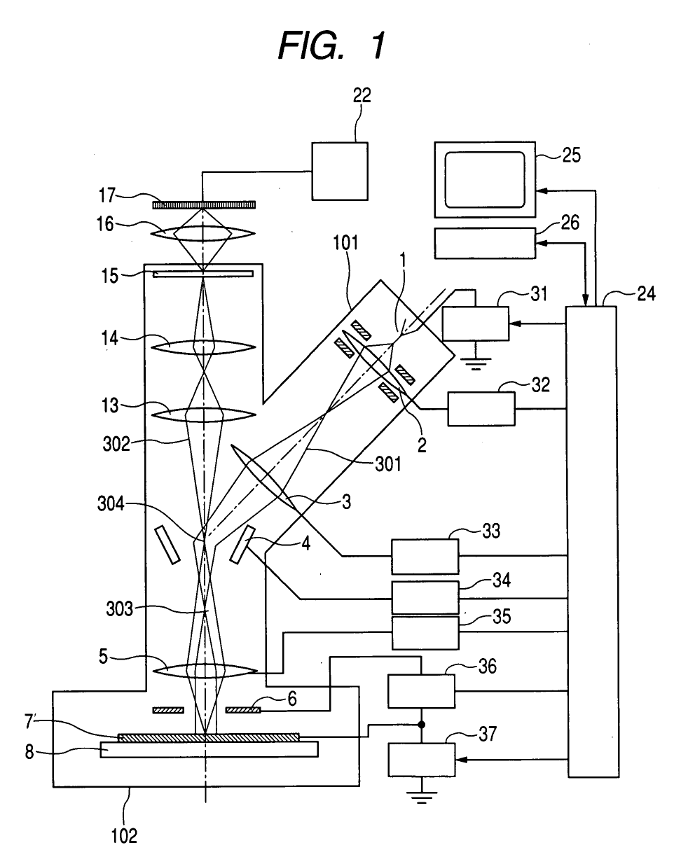

FIG. 1 shows a configuration of a mirror electron beam microscope for describing the operation in the first embodiment. An ExB deflector 4 used as a beam separator is disposed nearly to an imaging plane of a reflecting electron beam 302 that includes a mirror electron beam. An illumination system optical axis and an imaging system optical axis perpendicular to a wafer 7 respectively cross each other at a θ_{IN} angle. As described above, because an ExB deflector 4 used as a beam separator is disposed between a condenser 3 and an objective lens 5, the illuminating electron beam 301 emitted from an electron source 1 is deflected by the ExB deflector 4 to an optical axis perpendicular to the wafer 7. Electrons of the illuminating electron beam 301 deflected by the ExB deflector 4 are focused by the condenser lens 3 in the vicinity of a focal plane 303 of the objective lens 5, thereby the electrons of the illuminating electron beam 301 are illuminated onto the specimen 7 almost in parallel to the specimen 7.

The specimen 7 receives a negative potential applied from a specimen applying power supply 37 through a stage 8 that holds the specimen 7. The potential is almost equal to the potential of an accelerating voltage V₀ applied to the electron source 1. An aperture electrode 6 facing the specimen 7 receives a positive voltage of from several kV to several tens of kV from an aperture electrode applying power supply 36 with respect to the specimen 7. Most of the planar illuminating electron beam 301 is returned just before it collides with the specimen 7 by a retarding electric field between this aperture electrode 6 and the specimen 7, thereby the electrons become mirror electrons. The mirror electrons are entered to the objective lens 5 again in a direction and with an intensity affected by the shape, potential, magnetic field, etc. of the specimen 7.

A reflecting electron beam 302 consisting of those mirror electrons is magnified by the objective lens 5 to form a mirror projection image near to the ExB deflector 4. This ExB deflector 4 acts for the reflection electron beam under the Wien condition. In other words, the ExB deflector 4 does not act as a deflector for the reflecting electron beam 302. In addition, because a mirror electron image is formed and projected near to the ExB deflector 4, almost no deflection aberration is caused by the ExB deflector 4. The reflecting electron beam 302 projected by this objective lens 5 is projected by an intermediate lens 13 and by a projection lens 14 respectively, then an magnified mirror electron image is formed on a scintillator 15. This mirror electron image is converted to an optical image by the scintillator 15, then projected on a CCD camera 17 through an optical lens 16 or optical fiber flux. A mirror electron image, after it is converted to an electrical signal by the CCD camera 17, is displayed on a monitor 22.

In some cases, according to the illuminating condition, the reflecting electron beam 302 includes mirror electrons, as well as back-scattered electrons obtained when electrons collide with a specimen and scattered backward and secondary electrons generated secondarily from the specimen. Because the back-scattered electrons and the secondary electrons are varied in entering direction, the electrons entered to the scintillator 15 are limited to only those exited almost perpendicularly. Thus the rate of the back-scattered electrons and secondary electrons included in the mirror electrons is small and they do not affect the image contrast so much under the normal condition. If back-scattered electrons and secondary electrons are included in an image, a limiting stop can be inserted on an electron beam diffraction image plane formed on the focal plane of the objective lens 5 or a plane on which the electron beam diffraction image is projected by the intermediate lens 13 thereby to adjust the rate of those back-scattered electrons and secondary electrons included in the image. The limiting stop limits the angle of the reflection electron beam.

FIG. 8 shows a cross sectional view of the ExB deflector 4 from the perpendicular direction of the optical axis. The deflector 4 has an 8-pole electromagnetic pole structure. Each electromagnetic pole 51 is composed of a magnetic material such as a permalloy. Each electromagnetic pole 51 functions as an electrode when it receives a potential and flows an excitation current to a coil 53, which is formed with N rounds wound on each of the electromagnetic poles 51. If a voltage V_{X} is applied to each electromagnetic pole 51 according to the voltage distribution pattern shown in FIG. 8, electrons are deflected in the x direction. Furthermore, a current I_{Y} is flown to each coil 53 according to the current distribution pattern as shown in FIG. 9, electrons moving from the back side to the front side of the paper surface in FIG. 9 are deflected in the positive x direction while electrons moving from the front side to the back side of the paper surface in FIG. 9 are deflected in the negative x direction. The voltage and current distribution of each electrode are optimized to generate a uniform electromagnetic field according to the calculation of an electromagnetic field to give a potential or magnetic potential actually in an electromagnetic pole pattern. For example, it is set at α=0.414.

FIG. 10 shows a cross sectional view of the ExB deflector 4 including an optical axis. If the ExB deflector 4 is used as a beam separator, the angle θ_{IN} on which the illuminating system and the imaging system cross each other should be about 30 degrees after taking into account the mutual interference between those two optical systems that should be avoided. If the illuminating electron beam 301 is set so as not to collide with any electromagnetic pole even when it is deflected by 30 degrees, the diameter of the aperture must be set wider than the length of each of the electromagnetic poles 51. If the aperture is set wider, however, the deflecting voltage must be increased. This is why the shape of each of the electromagnetic poles 51 is determined to be widened toward the end (i.e., to be conical shape). Furthermore, a shield electromagnetic pole 54 is provided above and under each of the electromagnetic poles 51 respectively to suppress the leak from the electromagnetic field, as well as to make both the electric field and the magnetic field function in the same space, thereby it functions as a complete ExB deflector that always satisfies the Wien condition in the space.

The operation is described by assuming that the ExB deflector 4 makes deflection in the x direction. The same procedure can also be applied for the correction of the deflection in the y direction by supplying a voltage or current of the deflection in the y direction to the 8-pole electromagnetic electrode. For example, if a magnetic flux leak from a peripheral magnetic field lens is found in the ExB deflector 4, a rotation correction is needed to superimpose the electromagnetic field in this y direction. Furthermore, in FIG. 9, the number of winding in each of the coils is set as N times equally, the currents I and N may be changed within a range in which a relationship NI with the current I flown in each electromagnetic pole is fixed.

Next, how the reflecting plane of a mirror electron beam is to be adjusted will be described. An operation screen of the monitor 25 displays such information as the electron source applying voltage V0 applied to the electron source 1 through an electron source applying power supply 31, the specimen applying voltage Vs applied to the specimen 7 from the specimen applying power supply 37 through a stage 8 for holding the specimen 7, or such information as a difference ΔV of potentials between the specimen applying voltage and the electron source applying voltage. The aperture electrode 6 facing the specimen 7 receives an aperture electrode voltage Va from the aperture electrode applying power supply 36. The screen also displays such information as a distance L between the aperture electrode and the specimen, as well as such information as an electrical field strength E=(Va−Vs)/L between the aperture electrode and the specimen.

The input information about the material of an object wafer is inputted by the user through an input interface 26. A controller 24 stores a work function inputted beforehand according to the type of the specimen material. If the user inputs “SIO2”, the screen displays “ΔVw: 6.4 eV” as a difference of work functions obtained by subtracting a work function of the electron source 1, for example, a work function about 2.6 eV of a Zr/O/W type Schottky electron source, from the SIO2 work function 9 eV. If Vs0 is assumed for a specimen applying voltage Vs at which an illuminating electron beam having a reference energy collides with the specimen 7 at 0V, Vs0=V0−ΔVw will also be assumed for the illuminating electron beam of which reference energy is V0. Actually however, the energy distribution of the illuminating electron beam is varied according to the type and shape of the electron source 1 and a difference of work functions between the electron source 1 and the specimen 7 varies slightly according to the Seebeck effect caused by a contact between metals, so that a certain voltage correction voltage may be set in advance according to the type of the electron source 1.

FIG. 11 shows a relationship between the electron beam energy distribution and the energy level with respect to such a Schottky electron source as a Zr/0/W type one. The Schottky emitting electrons are emitted when the potential barrier goes lower than the vacuum reference due to an extracting electric field and the energy of the emitted electrons is distributed nearly to the vacuum level of the electron source. In order to make the electrons emitted from the energy of the vacuum level of the electron source get closer to the specimen just before the specimen, the difference of potentials between the electron source applying voltage and the specimen applying voltage is just required to be almost equal to the work function difference ΔVw between the electron source and the specimen. Actually, electrons having the highest energy of the electron source are larger by about ΔV1 than those of the vacuum level and the potential difference from the vacuum level of an energy equal to the maximum value of the energy distribution of the electron source is varied just by ΔV2. If the reference of the user is a voltage at which the electron beam having the maximum energy goes just before the specimen, Vs0=V0−ΔVw+ΔV1 is obtained. If the reference of the user is a voltage at which the electron beam having an energy equal to the maximum value of the energy distribution, Vs0=V0−ΔVw−ΔV2 is obtained. Those Δ1 and Δ2 values may be set automatically according to the condition of the electron source operation with reference to a measured values database that uses such conditions as measured values of the radius of the curvature, heating temperatures, extracting voltages as parameters. The user may also set those values as preset ones. Furthermore, the user may add such correction values as the Seebeck effect caused by a contact between metals, etc. to those Δ1 and Δ2 values.

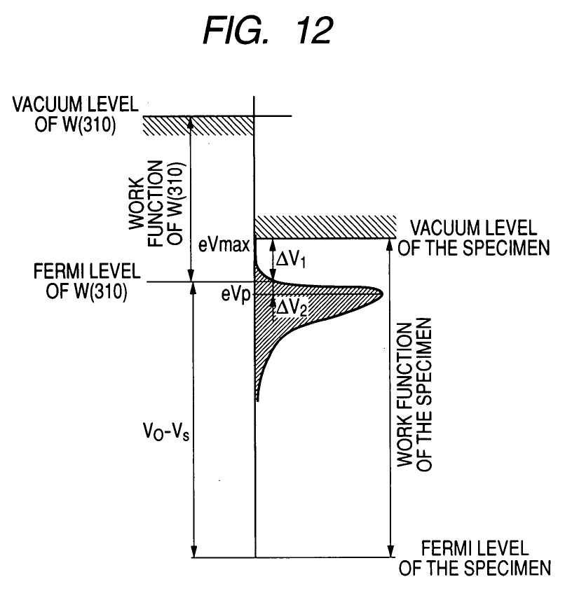

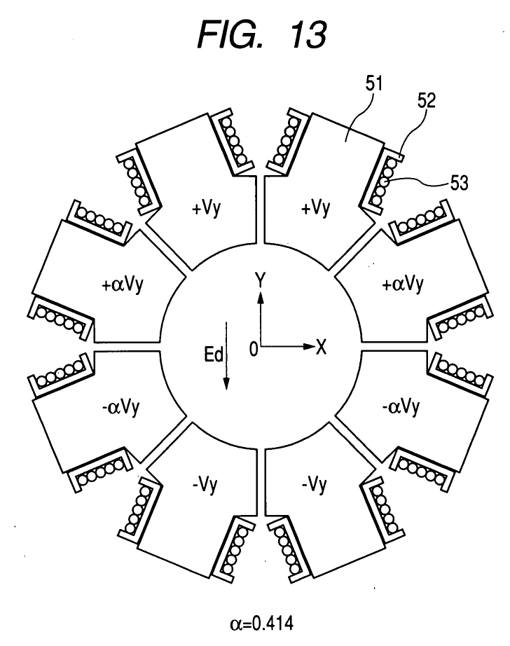

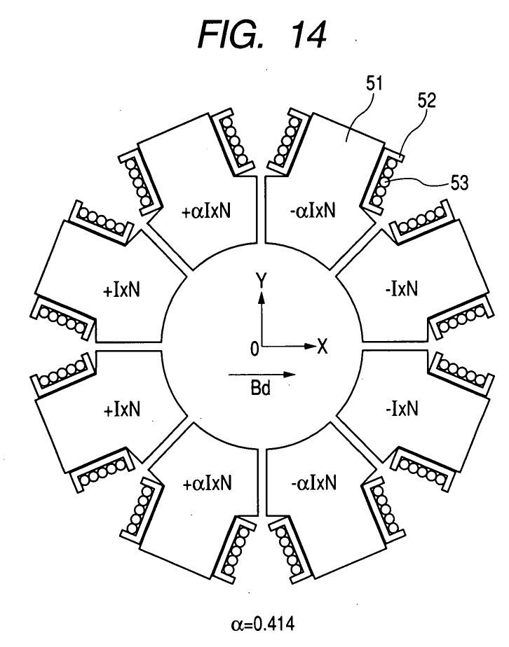

FIG. 12 shows a relationship between the electron beam energy distribution and the energy level with respect to such a field emission electron source as a W(310). Field emission electrons are emitted by a strong extracting electric field due to a tunneling effect. The energy of the emitted electrons is distributed nearly to the Fermi level of the electron source. In order to make the electrons emitted from the Fermi level energy get just before the specimen, the difference of potentials between the electron source applying voltage and the specimen applying voltage is just required to be equal to the work function Vf of the specimen. Actually, the electrons having the maximum energy of the electron source is larger by ΔV1 than those of the Fermi level and the potential difference from the Fermi level of the energy equal to the maximum value of the energy distribution of the electron source is just ΔV2. If the reference of the user is a voltage at which the electron beam having the maximum energy goes just before the specimen, Vs0=V0−Vf+ΔV1 is obtained. If the reference of the user is a voltage at which the electron beam having an energy equal to the maximum value of the energy distribution gets closer to the specimen just before the specimen, Vs0=V0−Vf−ΔV2 is obtained. Those Δ1 and Δ2 values may be set automatically according to the condition of the electron source operation with reference to a measured values database that uses such conditions as measured values of the radius of the curvature and extracting voltages as parameters. The user may also set those values as preset ones. Furthermore, the user may add such correction values as the Seebeck effect caused by a contact between metals, etc. to those Δ1 and Δ2 values.

This Vs0 may be obtained experimentally. For example, a current meter may be connected to the stage 8 to measure the current to be absorbed by the specimen 7 to determine the Vs0 value. At this time, the operation screen displays the absorbed current value and the user can adjust V0 or Vs with reference to the displayed absorbed current value to change the V0−Vs value. The condition under which the current becomes 0 is the same as the condition under which the entire illuminating electron beam makes mirror reflection. Therefore, the user can judge that the V0−Vs value at which the absorbed current begins flowing when the illuminating electron beam is put closer to the specimen meets a condition under which the illuminating electron beam having almost the maximum energy come into collision with the specimen 7, so that the user can set the V0−Vs value according to the judgment. Otherwise, the user can judge that the V0−Vs value indicating a condition that the absorbed current changes most significantly meets a condition under which the illuminating electron beam having an energy almost equal to the maximum value of the energy distribution come into collision with the specimen 7, so that the user can set the V0−Vs value according to the judgment. Furthermore, the user can display a mirror electron image on the operation screen and set the V0−Vs value as a condition under which the entire illuminating electron beam is reflected, thereby changing the V0−Vs value so as to make the illuminating electron beam get closer to the specimen 7 and measure the distribution of the illuminating electron beam. For example, the user can judge that the minimum intensity of the mirror electron image meets a condition under which the illuminating electron beam having the minimum energy come into collision with the specimen in most cases.

Furthermore, an energy value to be assumed as a reference value in the energy distribution of the electron beam obtained in the above procedure, for example, a V0−Vs value corresponding to the maximum energy value, an energy value equal to the maximum value of the energy distribution, or an energy value of the electron beam up to a certain rate in the energy distribution, may be stored beforehand in the controller. At this time, the operation screen displays mode buttons for selecting a reference energy value, which is the maximum energy value, an energy equal to the maximum value of the energy distribution, or an energy value of the electron beam up to a certain rate in the energy distribution. When the user selects a mode, the screen displays a V0−Vs value corresponding to the selected mode automatically.

The operation screen also displays the reflecting plane of an object mirror electron beam when the user sets 0 for the height H of the mirror electron beam reflecting plane, at which the electron beam having a reference energy value goes just before the specimen or the user inputs his/her specified height. The relationship between the variation AH of the mirror electron beam reflecting plane and the V0−Vs variation value ΔV₀₋ₛ is represented as ΔH=ΔV₀₋ₛ/E. Thus if the user specifies the reflecting plane interlocking mode, the ΔV₀₋ₛ is controlled to be changed in accordance with the input AH value. Furthermore, the ΔH=ΔV₀₋ₛ/E value can also be corrected, set, and displayed in accordance with a change of the electric field intensity E=(Va−Vs) between the aperture electrode and the specimen with respect to the changes of the specimen applying voltage Vs, the aperture electrode voltage Va, and the distance L between the aperture electrode and the specimen.

According to such conditions as the shape and type of the object specimen, the user can adjust the height H of the mirror electron beam reflecting plane manually and freely. Furthermore, according to such conditions as the shape, type, etc. of the specimen, an optimized reflecting plane height is already stored in the controller. Thus the V0−Vs value that is equal to the optimized reflecting plane height ΔH can be set automatically when the user selects a shape and a type of the object specimen.

### Second Embodiment

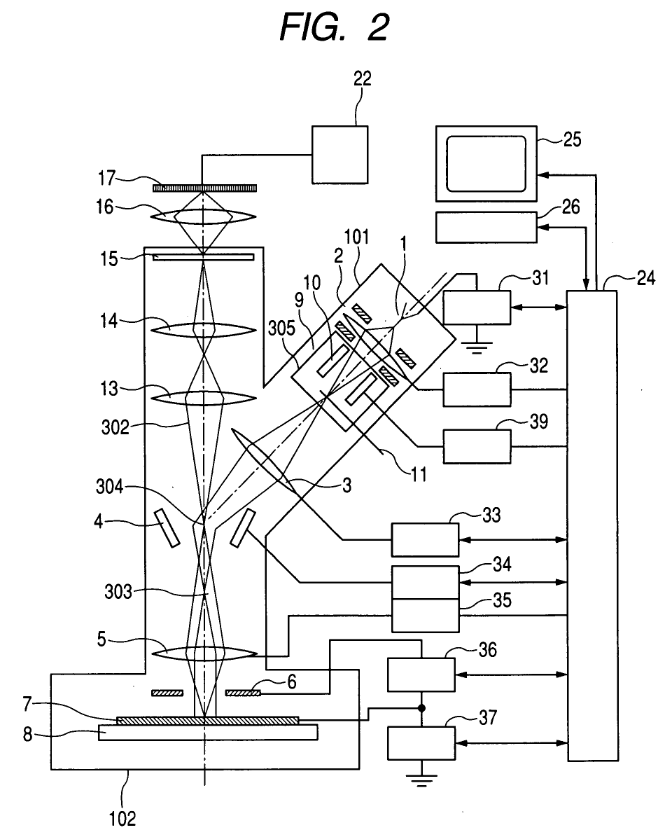

In this second embodiment shown in FIG. 2, an energy filter is mounted in an illuminating system of a mirror electron microscope to control the mirror reflecting plane. An energy filter 9 is disposed between an electron gun lens 2 and a condenser lens 3. An illuminating electron beam 101 emitted from an electron source 1 and passed through the energy filter 9 forms an energy-dispersed cross-over between the energy filter 9 and the condenser lens 3. On the cross-over is disposed a limiting stop 11 for selecting an energy of the illuminating electron beam. The illuminating electron beam 101 of which energy is selected is deflected to an optical axis perpendicular to a wafer 7 by a beam separator 4 disposed between the condenser lens 3 and an objective lens 5, then focused in the vicinity of an objective lens focal plane 303 by the condenser lens 3. The electrons of the illuminating electron beam can thus be illuminated perpendicularly onto a specimen 7 almost in parallel. The limiting stop 11 may be shaped, for example, like a knife edge when the high energy or low energy part is limited in the energy-dispersed cross-over and like a slit or a circle when a specific energy part is selected.

As the energy filter 9, for example, an ExB deflector 10 is used. The ExB deflector 10 is structured, for example, like an 8-pole electromagnetic electrode as shown in FIG. 8. Each electromagnetic pole 51 is made of such a magnetic material as permalloy. Each electromagnetic pole 51 functions as an electrode when it is given a potential. Each of the electromagnetic poles 51 functions as a magnetic pole when an excitation current is flown in a coil 53 consisting of those electromagnetic poles 51, each being wound by N times. Here, assume that the counter direction of the deflecting direction of the separator is the x direction of the energy filter. Then, if a voltage V_{X} is applied to each of the electromagnetic poles 51 in the voltage distribution pattern shown in FIG. 8, electrons are deflected in the x direction by the energy filter. If a current I_{Y} is flown in each of the coils in the current distribution pattern shown in FIG. 9, electrons moving from the back side to the front side of the paper surface shown in FIG. 9 are deflected in the positive x direction while electrons moving from the front side to the back side of the paper surface shown in FIG. 9 are deflected in the negative x direction. The distributions of both the voltage and the current of each electrode are optimized so as to generate a uniform electromagnetic field by calculating an electromagnetic field that has given a potential or magnetic potential actually to the shape of the electromagnetic poles. For example, α=0.414 is set in FIG. 9. The relationship between the electric field strength E_{F} in the vicinity of the optical axis of the ExB deflector 10 and each electromagnetic pole applying voltage V_{X}, as well as the relationship between the magnetic flux density BF in the vicinity of the optical axis of the ExB deflector 10 and each electromagnetic pole applying current I_{Y} are determined beforehand through an electromagnetic field calculation, etc.

The illuminating electron beam 101 has an energy distribution as shown in FIG. 11 with respect to, for example, such a Schottky electron source as a Zr/0/W type one. The distribution of the energy of the electron beam emitted from the illuminating electron beam 101 is almost the same as the energy distribution of the vacuum level although their energy values are not always equal. Thus if V₀ is assumed as an electron source applying voltage to be applied to the electron source 1 from the electron source applying power supply 31, the peak of the energy distribution of the electron beam passing the ExB deflector 10 almost matches with the energy eV₀, so that the energy eV_{F} going straight in the energy filter 9 can be adjusted by setting the ratio between the electric field intensity E_{F} and the magnetic flux density B_{F} to be supplied to the ExB deflector 10 on the basis of the eV₀ so as to satisfy the Wien condition.

$${E}_{F} = \sqrt{\frac{2 e}{m} {V}_{F} {B}_{F}} \qquad ( 5 )$$

The energy dispersion on the cross-over generated by the energy filter occurs in the same direction as the deflecting direction, but the energy dispersion scale can be adjusted by changing the E_{F} and B_{F} according to the intensity ratio so as to satisfy the Wien condition. For example, if the energy dispersion on the cross-over is set at 5 μm/eV, an electron beam having an energy width 0.4 eV can be selected and passed when a slit having a width of 2 μm is disposed perpendicularly to the deflection on the cross-over.

At this time, the operation screen of the monitor 25 displays such information as the electron source applying voltage V₀ applied to the electron source 1 through the electron source applying power supply 31, as the specimen applying voltage Vₛ applied to the specimen 7 through the stage 8 for holding the specimen 7 from the specimen applying power supply 37, or as the potential difference ΔV between the specimen applying voltage and the electron source applying voltage. Furthermore, an aperture electrode voltage Va is supplied to the aperture electrode 6 facing the specimen 7 from the aperture electrode applying power supply 36. The operation screen also displays the information of the distance L between the aperture electrode and the specimen, as well as the electric field intensity E=(Va−Vs)/L between the aperture electrode and the specimen. The user also sets and displays an energy width ΔE passing the slit having a width of 2 μm and the passing energy eV_{F} itself by changing the E_{F} and B_{F} for the operation of the ExB deflector 10. The user can also input the material of the object wafer through an input interface 26. A controller 24 stores a work function corresponding to the type of the specimen material set beforehand. So, if the user inputs “SIO2”, a work function difference ΔVw: 6.4 eV is displayed. The work function difference ΔVw: 6.4 eV is obtained by subtracting the work function of the electron source 1, for example, a work function about 2.6 eV of such a Schottky electron source as a Zr/0/W type one from the SIO2 work function 9 eV. If Vs0 is assumed as a specimen applying voltage Vs with which an illuminating electron beam having a reference energy collides with the specimen 7, Vs0=VF−ΔVw is satisfied with respect to the illuminating electron beam of which reference energy is V_{F}.

With the operations, the user determines the Vs0 value and sets 0 for the height H of the corresponding mirror electron beam reflecting plane or inputs a user-specified height. Because the relationship between the variation AH of the mirror electron beam reflecting plane and the V_{F}−Vs variation of V_{F}−V_{S} is represented by ΔH=ΔV_{F-S}/E, if the user specifies a reflecting plane interlocking mode, the ΔV_{F-S} value is also controlled to be changed in accordance with the inputted AH value. In other words, the ΔV_{F-S} can be controlled by changing the specimen applying voltage VS to be applied to the specimen 7 from the specimen applying power supply 37 or changing the energy eV_{F} passing the energy filter by adjusting the ratio of between the electric field intensity E_{F} and the magnetic flux density B_{F} to be supplied to the ExB deflector 10 as shown in the Wien conditional expression (4). Furthermore, the displayed ΔH=ΔV_{F-S}/E is also corrected and set in accordance with the change of the electric field intensity E=(Va−Vs)/L between the aperture electrode and the specimen with respect to the changes of the specimen applying voltage Vₛ, the aperture electrode voltage Va, and the distance L between the aperture electrode and the specimen.

According to such conditions as the shape and type, etc. of an object specimen, the user can adjust the height H of the mirror electron beam reflecting plane manually and freely. Furthermore, according to such conditions as the shape, type, etc. of the specimen, an optimized reflecting plane height is stored beforehand in the controller. Thus the user can select a shape and a material of an object specimen to set a V_{F}−VS value equally that is a corresponding optimized reflecting plane height ΔH.

Energy dispersion that occurs in the cross-over of the energy filter also occurs on the objective lens focal plane 303 through the condenser lens 3. Therefore if energy dispersion is made in a direction in which the energy dispersion is canceled by the energy dispersion caused by a deflection chromatic aberration generated in the beam separator 4, a cross-over in which no energy dispersion occurs is formed on the objective lens focal plane 303. If the condenser lens 3 is an electrostatic type one, the illuminating electron beam 101 does not rotate. Thus if the beam separator 4 and the energy filter 9 make deflection in the counter directions each other, the energy dispersion on the objective lens focal plane 303 can be canceled or eased.

If the condenser lens 3 is a magnetic field type one and it is assumed that the number of winding of the exciting coil of the condenser lens 3 is N, the exciting current is I, the energy of the illuminating beam 101 passing the condenser lens 3 is eV0, and the standardized lens exciting Ex is defined as follows,

Ex=IN/\sqrt{V0}

the rotation angle R changes about 11 degrees with respect to the change of Ex=1. At this time, if the deflection of the energy filter 9 is rotated in a direction counter to the deflection of the condenser lens 3 to correct the rotation angle R calculated from the operation condition of the condenser lens 3, the deflection aberrations of the beam separator 4 and the energy filter 9 can be eased. Here, it is also possible to control the voltage V_{Y} applied to each of the electromagnetic poles in a voltage distribution pattern shown in FIG. 13 and the current I flown in each of the coils in a current distribution pattern shown in FIG. 14 so as to satisfy the Wien condition with respect to the deflection of the ExB deflector used as an energy filter 9 in the y direction.

V_{w}=\sqrt{V_{X}²V_{Y}²}

Furthermore, Vx and Vy can be set to control the rotating direction of the energy dispersion of the energy filter 9 so that the absolute operation voltage value of the ExB deflector 10 that functions as an energy filter is fixed and the rotation angle R becomes tan(Vy/Vx). Furthermore, when the rotating direction of the energy dispersion of the energy filter 9 is set variably, the limiting stop 11 may be shaped like a circle larger in size when compared with the size of the energy dispersion. In other words, if 5 μm/eV is set for the energy dispersion on the cross-over and a circle limiting stop having a diameter of 100 μm or over is used, the limiting stop can function like a knife edge set almost orthogonally to each deflecting direction.

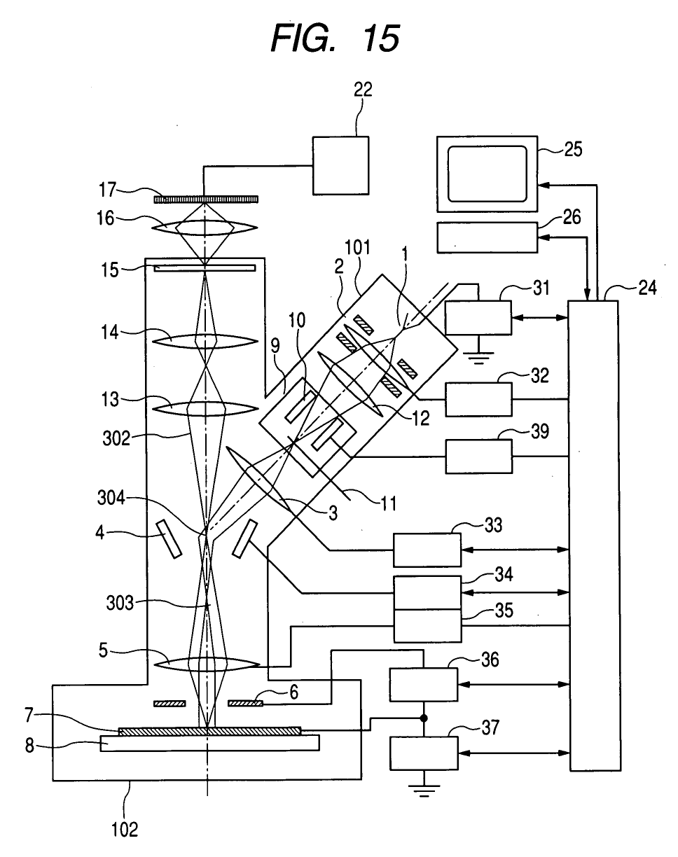

In the embodiment shown in FIG. 2, the energy filter 9 is disposed between the electron gun lens 2 and the condenser lens 3 and the illuminating electron beam 101 emitted from the electron source 1 and passed through the energy filter 9 forms an energy-dispersed cross-over between the energy filter 9 and the condenser lens 3. As shown in FIG. 15, however, it is also possible to enable the illuminating electron beam 101 to form such an energy-dispersed cross-over between the energy filter 9 and the condenser lens 3 by disposing a second condenser lens 12 between the electron gun lens 2 and the condenser lens 3, as well as an energy filter 9 between the second condenser lens 12 and the condenser lens 3. Furthermore, it is also possible to enable the illuminating electron beam 101 to form such an energy-dispersed cross-over between the energy filter 9 and the condenser lens 3 by disposing a second condenser lens 12 between the electron gun lens 2 and the condenser lens 3, as well as an energy filter 9 between the electron gun 2 and the condenser lens 3.

### Third Embodiment

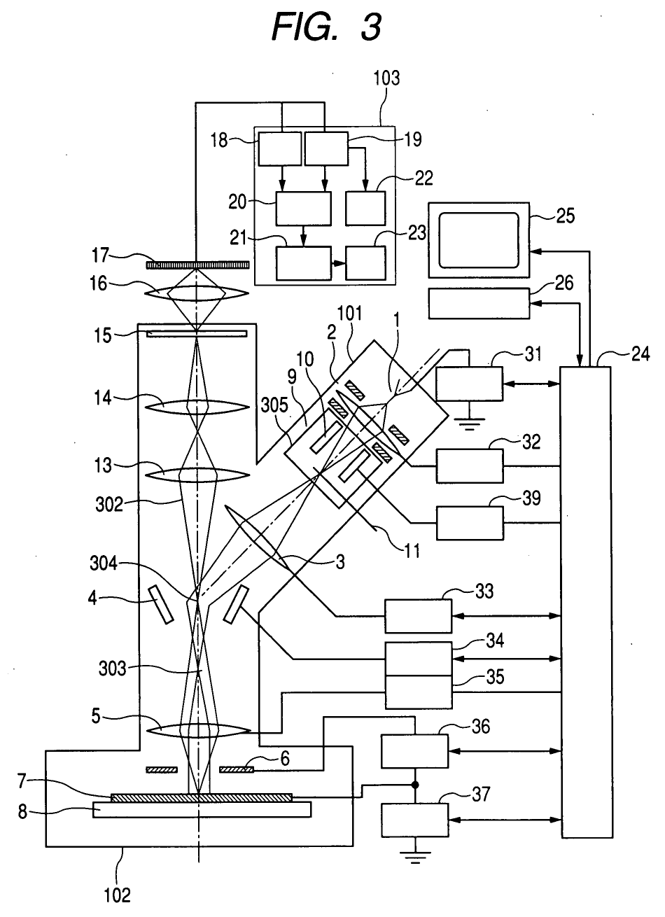

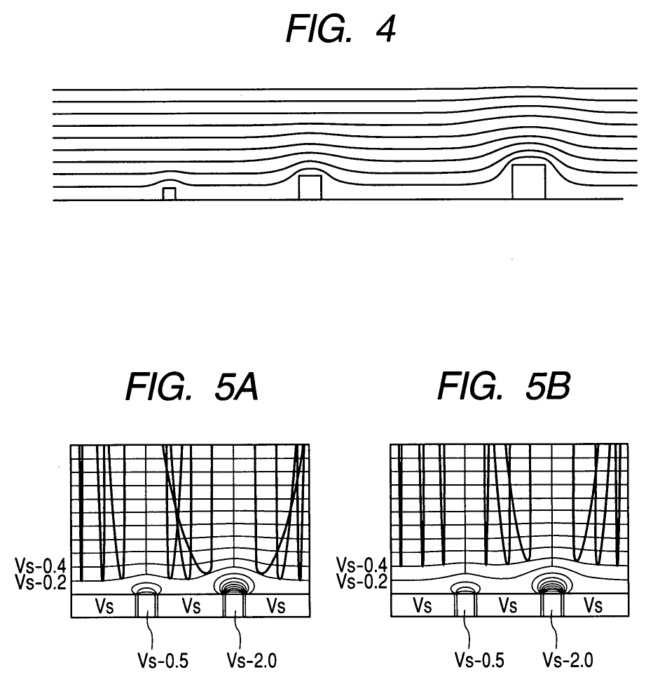

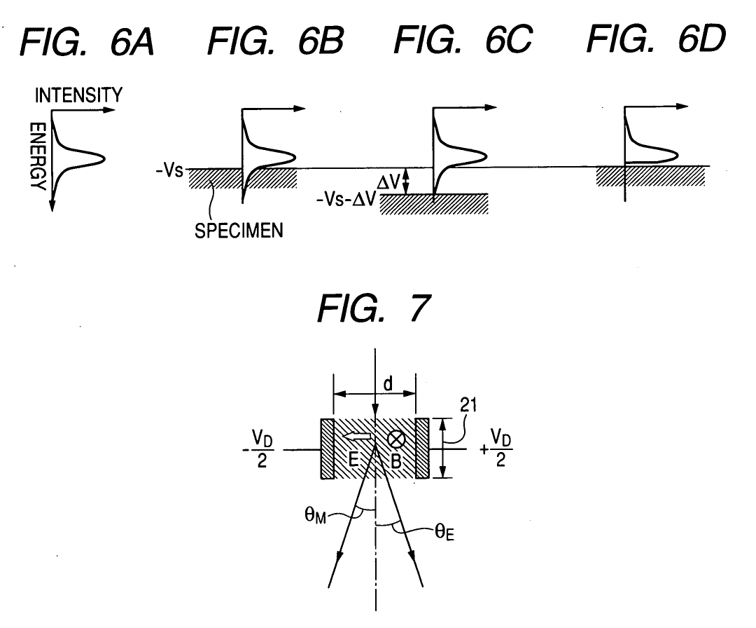

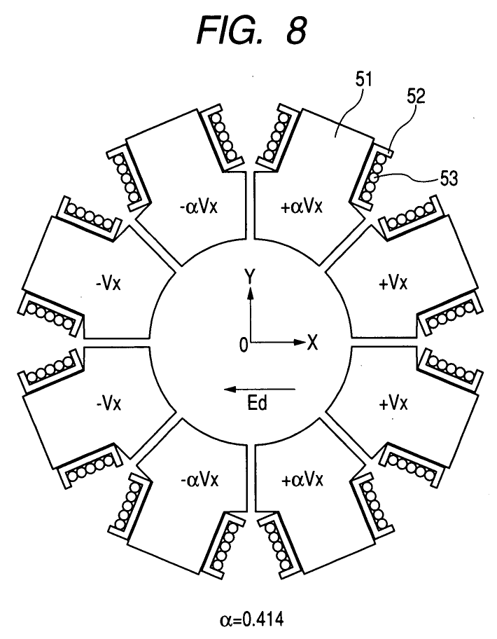

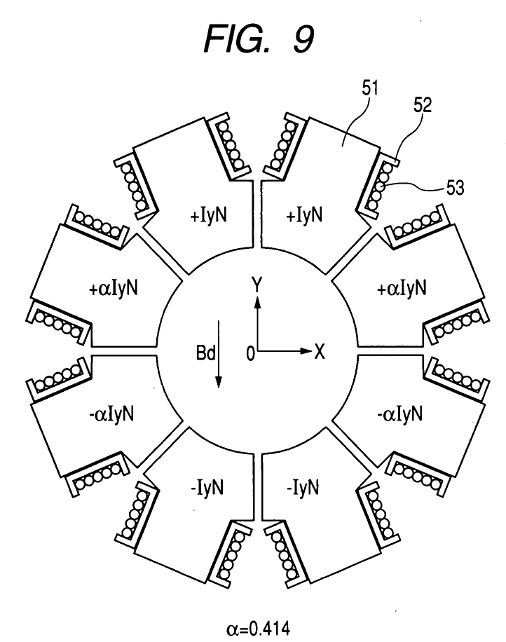

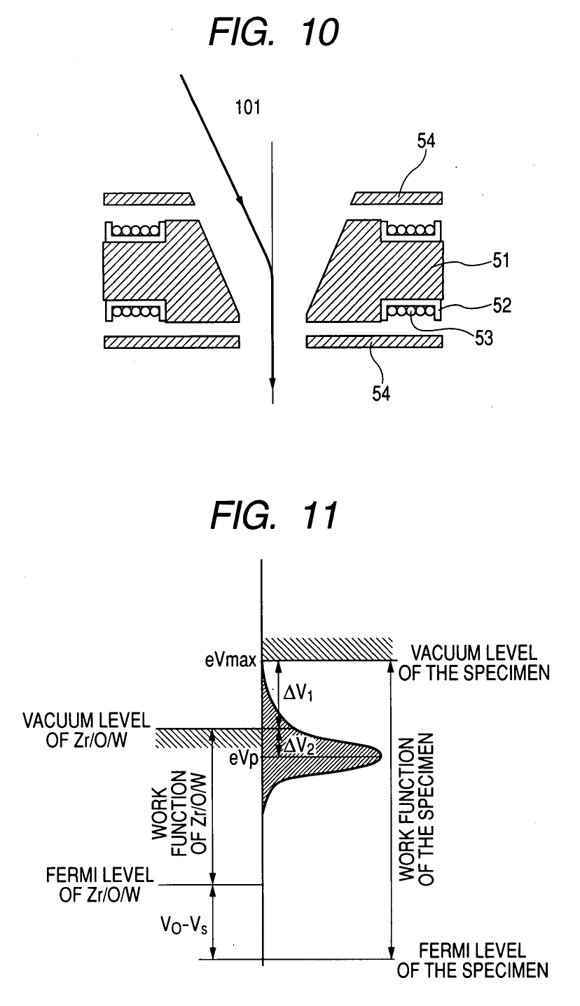

In this third embodiment shown in FIG. 3, a mirror electron microscope is employed for quick wafer inspection. An electron source 1 is a Zr/0/W type Schottky electron source having a tip of which radius is about 1 μm. With the use of this electron source, a uniform planar electron beam can be formed stably with a large current (ex., 1.5μ A) and at an energy width of 0.5 eV or under.

An energy filter 9 is disposed between an electron gun lens 2 and a condenser lens 3 and an illuminating electron beam 301 emitted from the electron source 1 passes through the energy filter 9, then forms an energy dispersed cross-over between the energy filter 9 and the condenser lens 3. On the cross-over is disposed a limiting stop 11 used to select an energy of the illuminating electron beam 101. The illuminating electron beam 101 of which an energy is selected passes the condenser lens 3, then deflected to an optical axis perpendicular to a wafer 7 by a beam separator disposed between the condenser lens 3 and an objective lens 10. As the beam separator, for example, an ExB deflector is employed and disposed in the vicinity of an image forming plane of a reflecting electron beam 302.

A mirror electron microscope mode is used for defect inspection. Mirror electrons change their trajectories due to a distortion of an equipotential surface formed just above the object specimen. However most of those mirror electrons can be used for image forming by adjusting the focal point of the image forming lens. In other words, using such mirror electrons makes it possible to obtain images with a high S/N ratio and reduce the inspection time.

Next, a description will be made for how to adjust a reflecting plane on an operation screen of a monitor 25. The operation screen of the monitor 25 displays such information as an electron source applying voltage V0, a specimen applying voltage Vs, or a potential difference between the specimen applying voltage and the electron source applying voltage ΔV. The operation screen also displays user inputted information of the material of an object wafer to be subjected to voltage measurement. A controller 24 stores beforehand a work function corresponding to the type of a specimen material. So, if the user inputs “SIO2”, the screen will display a work function difference ΔVw: 6.4 eV. The work function difference ΔVw: 6.4 eV is obtained by subtracting the work function of the electron source, for example, a work function about 2.6 eV of such a Schottky electron source as a Zr/0/W type one from the SIO2 work function 9 eV. If Vs0 is assumed as a specimen applying voltage Vs with which an illuminating electron beam 101 having a reference energy collides with the specimen 7, Vs0=V0−ΔVw is satisfied with respect to the illuminating electron beam of which reference energy is V0. Actually however, the energy distribution of the illuminating electron beam 101 comes to have a certain width and an energy shift according to the type and shape of the electron source 1. A difference between the work functions of the electron source 1 and the specimen 7 varies slightly according to such factors as the Seebeck effect caused by a contact between metals. This Vs0 can thus be obtained experimentally. For example, the Vs0 value can be determined by measuring a current absorbed by the specimen 7. Furthermore, the monitor 25 displays a result of an electric field distribution in the vicinity of the specimen 7 according to the voltage applying condition with respect to a specimen structure inputted to the controller in advance. If the user specifies a reference illuminating electron beam, the display 25 will display a reflecting plane on which an illuminating electron beam having the reference energy is reflected. If the user changes such a voltage condition as a specimen applying voltage, an electron source applying voltage, or the like, the electron beam trajectory is calculated again according to the inputted condition and points on which the entered electron beam is reflected respectively are connected to form a reflecting plane and the monitor 25 displays the formed reflecting plane. Otherwise, the monitor 25 displays an equipotential surface on which an electron beam having a reference energy in a flat specimen region for convenience. Thus the user can adjust the reflecting plane and determine inspection conditions according to the size and type of a target defect on the monitor 25.

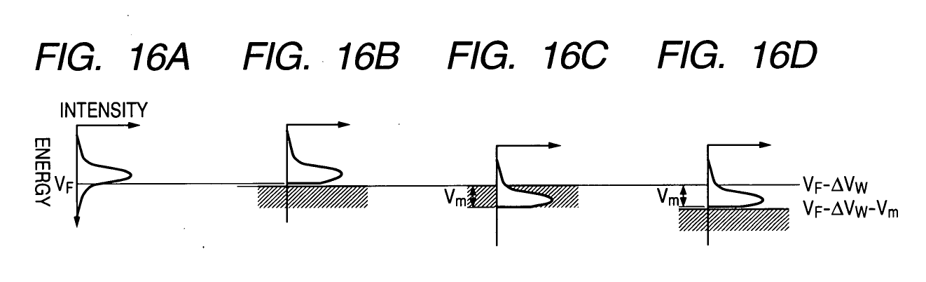

If the ExB deflector 10 is used as an energy filter 9 to select an energy of the illuminating electron beam 101, the limiting stop 11 for selecting an energy on the cross-over is disposed in the vicinity of the optical axis so that the Wien condition is satisfied with respect to the illuminating electron beam having an energy of eV_{F} in advance. Particularly, if an insulation specimen is illuminated with an electron beam having a high energy component at a high intensity by eliminating a weak distribution part of the high energy side, it is possible to obtain signals with high intensity, which reflect just above the insulation specimen, while controlling the charging state of the insulation specimen. Thus the insulation material can be observed continuously at a high resolution. For example, when eliminating high energy components of an energy eV_{F} or over with respect to an electron beam having an energy distribution pattern shown in FIG. 16A, it is just required to dispose a knife-edge-like limiting stop in the vicinity of the optical axis so that electron beams over an energy of eV_{F} are blocked by the limiting stop. If Vs0 is defined for a specimen applying voltage Vs at which an illuminating electron beam having a reference energy under this condition collides with the specimen at 0V, the reference energy is the maximum energy V_{F} of the illuminating electron beam 101. Thus Vs0=V_{F}−ΔVw is satisfied for the illuminating electron beam 101. Consequently, the electron beam with a high intensity is reflected just above the object specimen as a mirror electron beam, thereby the insulation specimen can be observed at a high resolution without charging the specimen (FIG. 16B). To charge an insulation material with a negative voltage of Vm, therefore, the illuminating electron beam having an energy of e(V_{F}+Vm) is reset so that the ExB deflector 10 satisfies the Wien condition or Vs=Vs0+Vm is set. Under such a condition, if the illuminating electron beam 101 is illuminated onto the specimen 7 continuously (FIG. 16C), the insulation film is kept charged negatively until the illuminating electron beam 101 begins repulsing and the charging is stabilized at a potential at which the number of electrons going into the insulation film and the number of electrons going out of the insulation film match with each other. Particularly, when the electrons accumulated in the insulation film do not escape to peripheral portions, the insulation film is stabilized after being charged negatively up to a potential of −Vm at which the illuminating electron beam 101 does not go into the insulation film any more. Even when the insulation film is charged negatively, an electron beam with a high intensity is reflected just above the specimen as a mirror electron beam. Thus the insulation film is observed at a high resolution.

The reflecting electron beam 102 consisting of mirror electrons coming up in a direction and at an intensity affected by the pattern information of the wafer 7 respectively is focused by the objective lens 5, The beam separator 4 is set so as not to deflect the reflecting electron beam 102 advanced from below. The reflecting electron beam 102 thus goes up perpendicularly as it is and magnified and projected by the intermediate lens 13 and the projection lens 14 to form an image of the surface of the wafer 7 on an image detecting part 15. Consequently, a local charge potential change and such structural differences as unevenness, etc. of the surface of the wafer 7 are imaged. This image is then converted to an electrical signal and transmitted to an image processing part 103.

The image processing part 103 is composed of image signal memories 18 and 19, a calculator 20, and a defect determination part 21. The image memories 18 and 19 store adjacent part images of the same pattern and the images stored in those memories 18 and 19 are calculated in the calculator 20 to detect different spots between those images. The result is determined as a defect in the defect determining part 21 and the defect coordinates are stored in another memory 23. A monitor 22 then displays an image according to the fetched image signals.

If an inspection is made by comparing the patterns of adjacent chips A and B having the same design pattern formed on the surface of a semiconductor wafer 7, at first the image processing part 103 fetches an electron beam image signal of an object inspection region in the chip A, then stores the signal in the memory 18. After that, the image processing part 103 fetches another image signal of an inspection region in an adjacent chip B, which corresponds to that in the chip A, then stores the signal in the memory 19. At the same time, the image processing part 103 compares the image signal stored in the memory 19 with the image signal stored in the memory 18. Then, the image processing part 103 fetches still another image signal of an object inspection region in the next chip C, which corresponds to the region in the chip B, then overwrites the signal on that stored in the memory 18. At the same time, the image processing part 103 compares the fetched image signal with that of the region in the chip B stored in the memory 19. Repeating such operations, the image processing part 103 stores image signals of object inspection regions corresponding to each another in all of the object inspection chips sequentially to continue a comparison between object two signals.

Apart from the method, there is another method employable for storing an electron beam image signal of a desired inspection region of a standard good (non-defect) specimen in the memory 18 in advance. In this case, inspection regions and inspection conditions of the standard (non-defect) specimen are inputted to the controller 24 in advance and an inspection is made for the standard specimen according to those inputted data and the image signal obtained for the desired inspection region is stored in the memory 18. Then, an object inspection wafer 7 is loaded onto a stage 8 and an inspection is made for the specimen in the same procedure as the above.

After that, the image processing part 103 stores an image signal of another inspection region corresponding to the above one in the memory 19 and compares the image signal in the memory 19 with the image signal of the above good specimen stored in the memory 18 previously. According to the result of the comparison, the image processing part 103 detects an existence of a pattern defect in the desired inspection region of the inspection specimen. As the above standard (non-defect) specimen, it is possible to use another wafer for which it is already known to have no pattern defect, as well as to use a region (chip) for which it is already known to no pattern defect. For example, in some cases when forming a pattern on the surface of a semiconductor specimen (wafer), an alignment failure may occur between lower and upper patterns all over the wafer surface. In such a case, if a comparison is to be made for patterns in the same wafer or in the same chip, such a failure (defect) existing on the entire wafer surface as described above is often overlooked.

According to this embodiment, however, because such a comparison is made between an image signal of a region that is already known to be good (non-defect) and stored in a memory and an image signal of another object inspection region, even a defect overlooked in the inspection of the entire wafer surface as described above can be detected accurately.

Both image signals stored in the memories 18 and 19 are transmitted to the calculator 20 respectively, then various statistical data (concretely, an average value of image density values and statistical data of dispersion, etc.), as well as a difference between adjacent pixels, etc. are calculated there according to the preset defect determination condition. Passing those processings, the image signals are transferred to the defect determination part 21 and compared with each other to extract a signal of difference between those signals. The signal of difference is then compared with the preset defect determination condition to make defect determination. The image signal of a pattern region determined as a defect is separated from image signals of other regions and the address of the defect region is stored in the memory 23.

Commands and conditions for the operation of each system component are input/output through the controller 24. The controller 24 stores such information as the preset accelerating voltage at the time of electron beam generation, the electron beam deflection width/deflection speed, the specimen stage moving speed, the timing of fetching an image signal from an image detecting element, etc. that are inputted beforehand. At the time of inspection, the stage 8 that holds a specimen 7 (semiconductor wafer) moves continuously at a constant speed in the x direction. Because the stage 8 moves such way, an electron beam is deflected by an illuminating system deflector 5 to make scanning by following the movement of the stage 8.

Each object illuminating region or position of an electron beam is kept monitored by a stage position measuring instrument, a specimen height measuring instrument, etc. provided at the stage 8. Those monitored information is transferred to the controller 24 so that an alignment error is checked in detail and corrected precisely. Consequently, precise alignment required for comparison and inspection of patterns is made quickly and precisely.

Furthermore, the surface height of the semiconductor wafer 7 is measured in real time with a means other than the electron beam, thereby the focal distances of the objective lens 5, the intermediate lens 13, and the projection lens 14 used for illuminating an electron beam are corrected dynamically. As the means provided other than the electron beam, for example, there is an optical height measuring instrument that employs a laser interference method, a reflecting beam position change measuring method, or the like. With the use of such a measuring instrument, focused electron beam images can always be formed on the surface of each object inspection region. Furthermore, it is also possible to measure warping of the wafer 7 before inspection to correct the focal distance according to the measured data. It may thus be omitted to measure the surface height of the wafer 7 at the time of inspection.

As described above, because the reflecting plane of an object mirror electron can be controlled such way, inspection can be made by distinguishing between classifying sizes and potentials of patterns, as well as high resolution images can be kept in inspection for insulation specimens.

1. A mirror electron microscope, comprising:
means for applying an accelerating voltage to an electron source;
specimen voltage applying means for applying a specimen voltage to a stage for holding said specimen;
an illuminating lens for illuminating an electron beam emitted from said electron source to said specimen as a planar illuminating electron beam having a two-dimensional extent;
means for controlling a reflecting plane of said mirror electron beam reflected without coming into collision with said specimen; and
means for converting said mirror electron beam to an image by projecting and magnifying said electron beam, then projecting and focusing said specimen image.

2. An inspection system, comprising:
means for applying an accelerating voltage to an electron source;
specimen voltage applying means for applying a specimen voltage to a stage for holding said specimen;
an illuminating lens for illuminating an electron beam emitted from said electron source to said specimen as a planar illuminating electron beam having a two-dimensional extent;
means for controlling a reflecting plane of said mirror electron beam reflected without coming into collision with said specimen;
means for converting said mirror electron beam to an image by projecting and magnifying said electron beam, then projecting and focusing said specimen image; and
means for inspecting the specimen from said image.

3. An inspection system, according to claim 2 further comprising:
means for determining a defect by making a comparison between a plurality of images of one pattern.

4. The mirror electron microscope according to claim 1;
wherein said means for controlling said reflecting plane of said mirror electron beam adjusts a height of said mirror electron beam reflecting plane with respect to a specimen surface by adjusting a relative voltage between said means for applying an accelerating voltage to an electron source and said specimen applying means.

5. The mirror electron microscope according to claim 4;
wherein the height of said mirror electron beam reflecting plane is adjusted by controlling a relative voltage between said means for applying an accelerating voltage to an electron source and said specimen applying means according to a potential difference between said specimen and an electrode facing said specimen, as well as according to an electric field intensity between said specimen and said electrode facing said specimen, determined by a distance between said specimen and said electrode facing said specimen.

6. The mirror electron microscope or defect inspection system according to claim 1;
wherein said means for controlling the height of said mirror electron beam reflecting plane also includes means for adjusting the energy distribution of said illuminating electron beam and controls a rate of said mirror electron beam reflecting from a certain height reflecting plane.

7. The mirror electron microscope according to claim 6;
wherein said means for adjusting the energy distribution of said illuminating electron beam eliminates high energy components of said illuminating beam.

8. The mirror electron microscope according to claim 6;
wherein the microscope or defect inspection system also includes means for controlling charging of an insulation specimen by eliminating high energy components of said illuminating electron beam.

9. The mirror electron microscope according to claim 6;
wherein said means for adjusting the energy distribution of said illuminating beam eliminates low energy components of said illuminating beam.

10. The mirror electron microscope according to claim 6;
wherein said means for adjusting the energy distribution of said illuminating beam illuminates an electron beam within a specific range of energy of said illuminating beam.

11. The mirror electron microscope according to claim 1;
wherein said mirror electron beam reflecting plane is controlled on the basis of a plane on which electrons having the maximum energy in said illuminating electron beam is reflected.

12. The mirror electron microscope according to claim 1;
wherein said mirror electron beam reflecting plane is controlled on the basis of a plane on which an electron beam is reflected with an energy obtained in a section of said illuminating electron beam, which has an energy value almost equal to the maximum.

13. The mirror electron microscope according to claim 1;
wherein said mirror electron beam reflecting plane is controlled on the basis of a plane on which an electron beam up to a certain rate in said illuminating electron beam is reflected.

14. The mirror electron microscope according to claim 1;
wherein said mirror electron beam reflecting plane is controlled according to a type of said specimen.

15. The inspection system according to claim 2;
wherein said mirror electron beam reflecting plane is controlled according to an object defect.

16. A mirror electron microscope, comprising:
an electron source;
means for illuminating an area beam on a specimen with an illuminating lens system including an electron gun lens for accelerating and focusing an illuminating electron beam emitted from said electron source, a condenser lens, and an objective lens;
means for magnifying and projecting a mirror electron beam reflected without coming into collision with a specimen with said objective lens, an intermediate lens, and an imaging lens; and
means for separating said mirror electron beam from said illuminating electron beam with a separator;
wherein said mirror electron microscope further includes means for selecting an energy of said illuminating electron beam with an energy filter disposed near to a cross-over of said illuminating electron beam formed by said electron gun lens.

17. The mirror electron microscope according to claim 16;
wherein said mirror electron microscope further includes means for easing or canceling the energy dispersion of said illuminating electron beam caused by said energy filter with the energy dispersion caused by said separator.

18. The mirror electron microscope according to claim 17;
wherein said mirror electron microscope further includes means for adjusting the direction of deflection by said energy filter on the basis of the direction of deflection by said separator.

19. The mirror electron microscope according to claim 18;
wherein said mirror electron microscope further includes means for adjusting the direction of deflection by said energy filter on the basis of the intensity of excitation of a condenser lens disposed between said energy filter and said separator.

20. The mirror electron microscope according to claim 16;
wherein said energy filter and said separator are ExB filters in which a magnetic field and an electric field cross each other.

21. The inspection system according to claim 2;
wherein said means for controlling said reflecting plate of said mirror electron beam adjusts a height of said mirror electron beam reflecting plane with respect to a specimen surface by adjusting a relative voltage between said means for applying an accelerating voltage to an electron source and said specimen applying means.

22. The inspection system according to claim 21;
wherein the height of said mirror electron beam reflecting plane is adjusted by controlling a relative voltage between said means for applying an accelerating voltage to an electron source and said specimen applying means according to a potential difference between said specimen and an electrode facing said specimen, as well as according to an electric field intensity between said specimen and said electrode facing said specimen, determined by a distance between said specimen and said electrode facing said specimen.

23. The inspection system according to claim 2;
wherein said means for controlling the height of said mirror electron beam reflecting plane also includes means for adjusting the energy distribution of said illumination electron beam and controls a rate of said mirror electron beam reflecting from a certain height reflecting plane.

24. The inspection system according to claim 23;
Wherein said means for adjusting the energy distribution of said illuminating electron beam eliminates high energy components of said illuminating beam.

25. The inspection system according to claim 23;
wherein the microscope or defect inspection system also includes means for controlling charging of an insulation specimen by eliminating high energy components of said illuminating electron beam.

26. The inspection system according to claim 23;
wherein said means for adjusting the energy distribution of said illuminating beam eliminates low energy components of said illuminating beam.

27. The mirror electron microscope according to claim 23;
wherein said means for adjusting the energy distribution of said illuminating beam illuminates an electron beam within a specific range of energy of said illuminating beam.

28. The inspection system according to claim 2;
wherein said mirror electron beam reflecting plane is controlled on the basis of a plane on which electrons having the maximum energy in said illuminating electron beam is reflected.

29. The inspection system according to claim 2;
wherein said mirror electron beam reflecting plane is controlled on the basis of a plane on which an electron beam is reflected with an energy obtained in a section of said illuminating electron beam, which has an energy value almost equal to the maximum.

30. The inspection system according to claim 2;
wherein said mirror electron beam reflecting plane is controlled on the basis of a plane on which an electron beam up to a certain rate in said illuminating electron beam is reflected.

31. The inspection system according to claim 2;
wherein said mirror electron beam reflecting plane is controlled according to a type of said specimen.
